(19) United States
(12) Patent Application Publication
(10) Pub. No.: US 2025/0196401 A1
(43) Pub. Date: Jun. 19, 2025

(54) COMPOSITE MATERIAL PARTS FORMING APPARATUS

(71) Applicants: Hyundai Motor Company, Seoul (KR); Kia Corporation, Seoul (KR); KOLON SPACEWORKS CO.,LTD., Gyeongsangnam-do (KR)

(72) Inventors: Youjin Park, Hwaseong-si (KR); Hyunyi Kwon, Hwaseong-si (KR); Jae Young Lee, Hwaseong-si (KR); Jae Kuk Park, Seoul (KR); Chang Hee Lee, Seoul (KR); Young Ju Kim, Seoul (KR)

(21) Appl. No.: 18/946,354

(22) Filed: Nov. 13, 2024

(30) Foreign Application Priority Data
Dec. 15, 2023 (KR) 10-2023-0183581

(51) Int. Cl. B29C 33/30; B29C 70/46

(52) U.S. Cl. CPC B29C 33/305; B29C 70/46

(57) ABSTRACT

An embodiment composite material parts forming apparatus includes a core mounted on an upper mold of a press mold, an insert pin connected to the core and configured to secure a nut, and a barrier which protrudes along an edge of the core with the insert pin disposed inside.

### CROSS-REFERENCE TO RELATED APPLICATIONS

This application claims the benefit of Korean Patent Application No. 10-2023-0183581, filed on Dec. 15, 2023, which application is hereby incorporated herein by reference.

### TECHNICAL FIELD

The present invention relates to a composite material parts forming apparatus.

### BACKGROUND

Typically, a plurality of panels is assembled into a vehicle body. Examples of panels include side outer panels, roof panels, and hood panels.

These panels are manufactured by forming blanks of steel material using a press mold.

However, in the case of this molding method, the development period for the press mold is long and the development cost can also be excessive. Furthermore, a painting process is also required to paint panels of press-formed steel material.

Accordingly, recently, a molding technology for composite material panels, such as plastic composite material panels, is being introduced, which are advantageous for small-scale production of panels, can help reduce the weight of vehicles, and do not require painting.

A composite material panel can be manufactured by forming a composite material molding source into a predetermined shape through a press mold.

The composite material panels can be assembled with related parts (e.g., vehicle bodies) through fastening members including a combination of bolts and nuts (commonly referred to as ‘hardware’ by a person of ordinary skill in the art).

For this purpose, the composite material panel has, in one example, a nut inserted into the boss portion. The composite material panels can be joined to corresponding parts by bolts engaged with nuts.

These nuts are fixed to the mold pins installed in the press mold and can be fixed by being inserted into the mold source during press molding of the mold source.

However, if the nut is not in close contact with the mold pin or there is no sealing between the mold pin and the nut, the molding source may inflow into the interior of the nut and harden. This may cause quality problems in composite material panels.

To improve this, a sealing material, such as an O-ring, is applied between the mold pin and the nut.

However, since the sealing material must be replaced or mounted manually each time a composite material panel is formed, work efficiency may decrease. Additionally, it can cause quality problems, such as the sealing material coming off the mold pin and becoming stuck in the nut.

The information contained in this background section has been prepared to promote understanding of the background of embodiments of the invention and may include matters that are not already known prior art.

### SUMMARY

The present invention relates to a composite material parts forming apparatus. Particular embodiments relate to a composite material parts forming apparatus for forming composite material parts such as a vehicle body panel.

Embodiments of the present disclosure provide a composite material parts forming apparatus that can solve the problem of a composite material forming source and a sealing material becoming stuck in a nut.

A composite material parts forming apparatus that forms a composite material molding source into a predetermined shape by a press mold and inserts a nut is provided. The composite material parts forming apparatus according to an embodiment may include a core mounted in the press mold, an insert pin connected to the core to secure the nut, and a barrier which protrudes along an edge of the core with the insert pin disposed on the inside.

The core may be mounted on an upper mold of the press mold.

The barrier may be formed in a circular cross-section shape at the edge of the core.

The barrier may be formed in the form of a cross-section of a polygon at the edge of the core.

The composite material parts forming apparatus according to an embodiment may further include a sealing member fixed between the core and the insert pin.

The insert pin may include a core connection pin portion in which a male thread is formed and a nut connection pin portion connected to the core connection pin portion with an exterior diameter larger than an exterior diameter of the core connection pin portion.

The core may further include a pin engage hole having a female thread formed on an inner surface to enable screw engagement with the core connection pin portion.

The sealing member may be pressed against an edge of the pin engage hole and be secured to a stepped portion between the core connection pin portion and the nut connection pin portion.

The nut may be provided in the form of a cap nut that can be fitted into the insert pin.

The nut may be connected to the insert pin in tight fitting.

According to the composite material parts forming apparatus according to an embodiment, when insert molding the nut, the composite material molding source inflowing into the seat surface and interior of the nut can be blocked by the sealing member and the barrier, so that a quality problem of the composite material molding source getting caught in the nut can be solved.

In addition, the effects that can be obtained or expected from embodiments of the present invention are directly or implicitly disclosed in the detailed description of the embodiments of the present invention. That is, various effects predicted according to embodiments will be disclosed in the detailed description that follows.

### BRIEF DESCRIPTION OF THE DRAWINGS

Since these drawings are for reference in explaining exemplary embodiments of the present invention, the technical ideas of the embodiments of the present invention should not be interpreted as limited to the attached drawings.

FIG. 1 is a drawing showing a composite material parts forming apparatus according to an embodiment.

FIG. 2 is a drawing showing a composite material panel manufactured by the composite material parts forming apparatus according to an embodiment.

FIG. 3 is a perspective view illustrating a mold pin assembly applied to the composite material parts forming apparatus according to an embodiment.

FIG. 4 is an exploded perspective view illustrating the mold pin assembly applied to the composite material parts forming apparatus according to an embodiment.

FIG. 5 is a cross-sectional view illustrating the mold pin assembly applied to the composite material parts forming apparatus according to an embodiment.

FIG. 6 is a drawing to explain the operation of a composite material parts forming apparatus according to an embodiment.

FIG. 7 is a drawing illustrating an exemplary variation of a mold pin assembly applied to the composite material parts forming apparatus according to an embodiment.

The following reference identifiers may be used in connection with the drawings to describe various features of embodiments of the present invention.

1: vehicle body
1a: engage hole
3: composite material panel
4: plastic main body
5: hood panel
6: boss portion
7: bolt
9: nut
11: composite material molding source
12: fiber material
20: press mold
21: lower mold
23: upper mold
30, 130: mold pin assembly
31, 131: core
33: pin engage hole
35: female thread
41: insert pin
43: core connection pin portion
45: nut connection pin portion
47: male thread
49: stepped portion
51: sealing member
61, 161: barrier
71: engraved groove
100: composite material parts forming apparatus

It should be understood that the drawings referenced above are not necessarily drawn to scale, but rather present rather simplified representations of various preferred features illustrating the basic principles of embodiments of the present invention. For example, specific design features of embodiments of the present invention, including particular dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, embodiments of the present invention will be described in detail so that those skilled in the art can easily implement the embodiments of the present invention. As those skilled in the art would realize, the described embodiments may be modified in various different ways, all without departing from the spirit or scope of the embodiments of the present invention.

The terminology used herein is for the purpose of describing specific embodiments only and is not intended to limit the embodiments. As used herein, singular forms are intended to also include plural forms, unless the context clearly indicates otherwise.

As used herein, the terms ‘comprise’ and/or ‘comprising’ indicate the presence of specified features, integers, steps, operations, elements, and/or components, but may also include one or more other features, integers or steps. It should also be understood that this does not exclude the presence or addition of elements, operations, components, and/or groups thereof.

As used herein, the term ‘and/or’ includes any one or all combinations of one or more items listed in association.

The term ‘connected’ in this specification indicates a physical relationship between two components in which the components are directly connected to each other or indirectly connected through one or more intermediary components.

As used herein, ‘vehicle,’ ‘vehicular,’ ‘automotive,’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based purpose built vehicles (PBVs), hydrogen-powered vehicles, and other alternative fuel vehicles (e.g., other than petroleum fuel derived from resources).

Hereinafter, embodiments of the present invention will be described in detail with reference to the accompanying drawings.

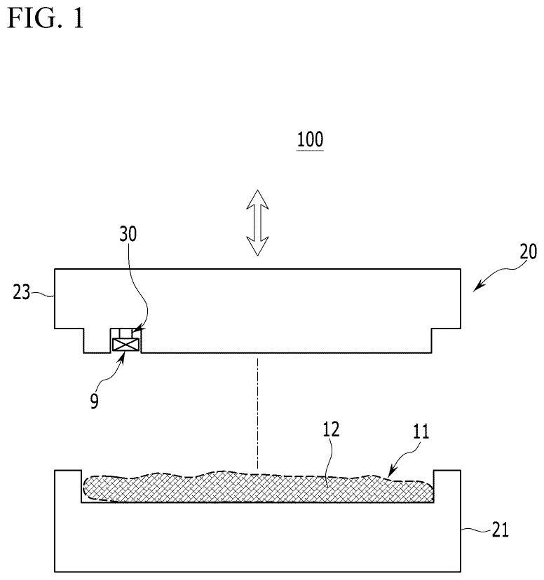

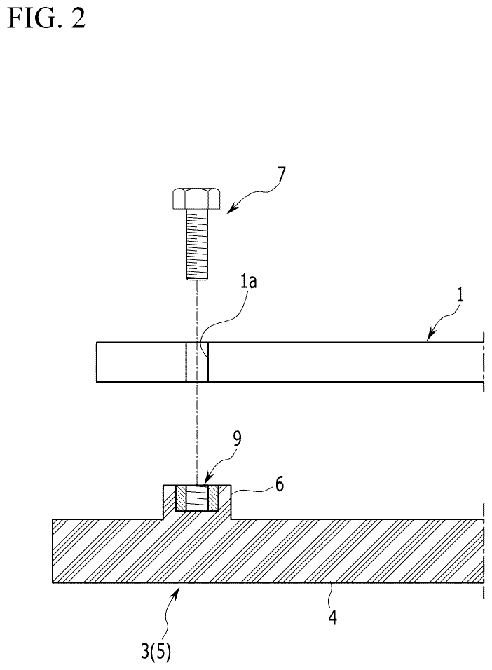

FIG. 1 is a drawing showing a composite material parts forming apparatus according to an embodiment, and FIG. 2 is a drawing showing a composite material panel manufactured by the composite material parts forming apparatus according to an embodiment.

Referring to FIG. 1 and FIG. 2, a composite material parts forming apparatus 100 according to an embodiment may be applied to a process of manufacturing a composite material panel 3, which is a part assembled to a vehicle body 1, for example.

The composite material panel 3 may, in one example, include a hood panel 5 of a vehicle.

The composite material panel 3 may be engaged to the vehicle body 1 by a fastening member including, in one example, a combination of a bolt 7 and a nut 9.

The bolt 7 may be connected to the engage hole 1a formed in the vehicle body 1. In an embodiment of the present invention, the nut 9 may be provided as a cap nut, for example, an insert nut, inserted into the composite material panel 3 to be fastened with the bolt 7.

The composite material panel 3 may be manufactured by molding a composite material molding source 11 into a predetermined shape through a press mold 20 and inserting the nut 9 into the composite material molding source 11.

The composite material molding source 11 may include a fiber material 12 and a thermosetting resin. The fiber material 12 may include one or more fibers, for example, carbon fiber, glass fiber, and aramid fiber.

Additionally, the composite material molding source 11 may include a polyurethane compound. Such composite material molding source 11 is obvious to those skilled in the art, and thus a detailed description thereof is omitted.

The composite material parts forming apparatus 100 according to an embodiment includes the press mold 20 provided with a lower mold 21 and an upper mold 23.

The upper mold 23 is installed so as to be able to move in the vertical direction relative to the lower mold 21. The upper mold 23 presses a gel-type composite material molding source 11 sprayed onto the lower mold 21 and may mold the composite material panel 3 of a predetermined shape.

The press mold 20 includes a mold pin assembly 30 to be installed in the upper mold 23. The mold pin assembly 30 is configured to secure the nut 9 to be inserted into the composite material molding source 11 during operation of the upper mold 23.

The mold pin assembly 30 may insert the nut 9 into the composite material molding source 11 by the operation of the upper mold 23 while the nut 9 is fixed. And, the mold pin assembly 30 may be separated from the nut 9 by the operation of the upper mold 23 while the nut 9 is fixed to the composite material molding source 11 by the hardening of the composite material molding source 11.

The nut 9 is inserted into at least one boss portion 6 molded into the plastic main body 4 of the composite material panel 3 and may be fixed to the boss portion 6.

In this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

In this specification, an end of a component (e.g., one end or another (other) end, etc.) denotes an end of a component in any one direction, and an end portion of the component (e.g., one end portion) or other (another) end portion, etc.) denotes a portion of a component that includes that end.

The composite material parts forming apparatus 100 according to an embodiment provides a structure that can prevent the composite material molding source 11 from inflowing into the interior of the nut 9 when forming the composite material panel 3 using the press mold 20.

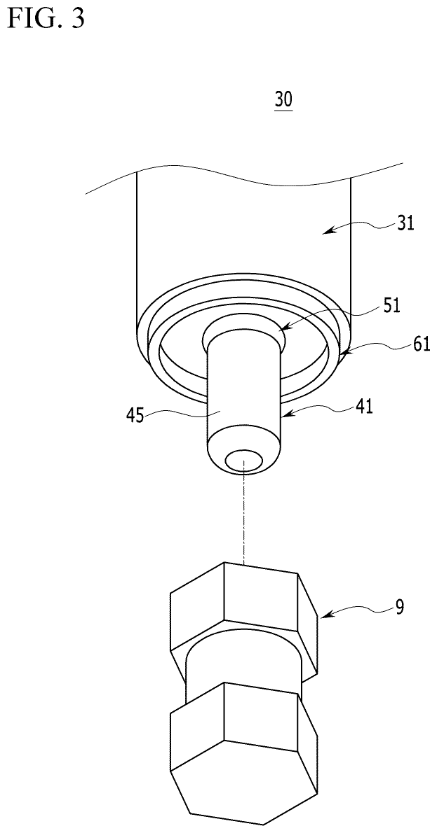

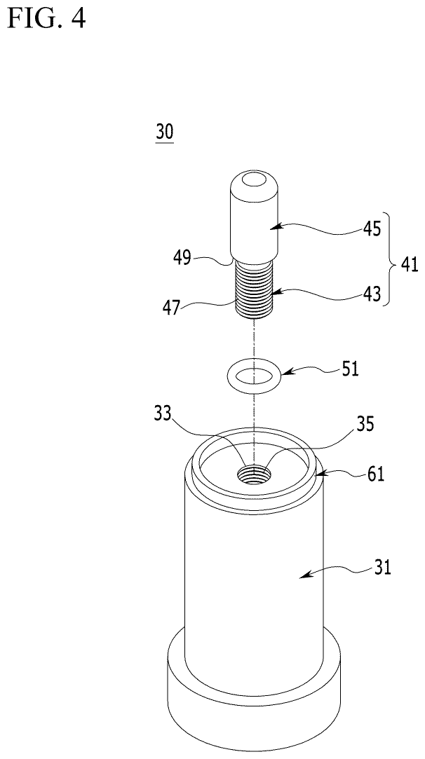

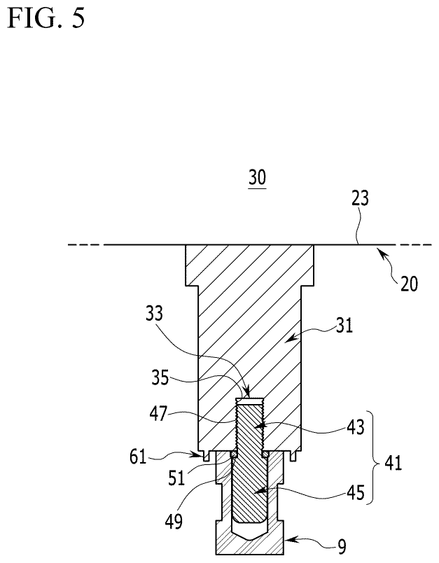

FIG. 3 is a perspective view illustrating a mold pin assembly applied to the composite material parts forming apparatus according to an embodiment, FIG. 4 is an exploded perspective view illustrating the mold pin assembly applied to the composite material parts forming apparatus according to an embodiment, and FIG. 5 is a cross-sectional view illustrating the mold pin assembly applied to the composite material parts forming apparatus according to an embodiment.

Referring to FIG. 3 to FIG. 5, the mold pin assembly 30 applicable to the composite material parts forming apparatus 100 may include a core 31, an insert pin 41, and a barrier 61.

In an embodiment, the core 31 is mounted in the upper mold 23 of the press mold 20. In one example, the core 31 may be provided as a block having a circular cylinder shape.

In an embodiment, the insert pin 41 is coupled to the core 31 to secure the nut 9.

The insert pin 41 includes a core connection pin portion 43 connected with the core 31 and a nut connection pin portion 45 connected with the nut 9.

The core connection pin portion 43 may be engaged into a pin engage hole 33 formed in the core 31.

A female thread 35 is formed on the inner surface of the pin engage hole 33. On the exterior circumference surface of the core connection pin portion 43, a male thread 47 capable of screw engagement with the female thread 35 is formed.

The nut connection pin portion 45 is configured to connect (or secure) the nut 9. The nut connection pin portion 45 extends from the core connection pin portion 43 with an exterior diameter larger than an exterior diameter of the core connection pin portion 43.

The nut 9 may be connected to the nut connection pin portion 45 of the insert pin 41 in a tight fitting manner (e.g., interference fitting, friction fitting, or force-fitting). The nut 9 is provided in the form of a cap nut that can be fitted into the nut connection pin portion 45, in one example. That is, the nut 9 may be provided in a form where one end is open and the other end is closed.

The mold pin assembly 30 applicable to the composite material parts forming apparatus 100 according to an embodiment may further include a sealing member 51.

The sealing member 51 is configured to seal between the nut connection pin portion 45 of the insert pin 41 and the nut 9. In one example, the sealing member 51 may include an O-ring of rubber material.

The sealing member 51 is secured between the nut connection pin portion 45 of the insert pin 41 and the core 31.

The sealing member 51 is fitted into the core connection pin portion 43 of the insert pin 41 and may be secured to a stepped portion 49 between the core connection pin portion 43 and the nut connection pin portion 45.

When the sealing member 51 is fitted into the core connection pin portion 43 and the core connection pin portion 43 is screw engaged into the pin engage hole 33 of the core 31, the sealing member 51 is in close contact with the edge of the pin engage hole 33 and may be secured to the stepped portion 49 between the core connection pin portion 43 and the nut connection pin portion 45.

In an embodiment, the barrier 61 is configured to control the flow direction of the composite material molding source 11 around the nut 9 when the nut 9 coupled to the nut connection pin portion 45 of the insert pin 41 is inserted into the composite material molding source 11 by the operation of the press mold 20.

The barrier 61 is configured to block the composite material molding source 11 from inflowing into the interior of the nut 9 through the space between the nut connection pin portion 45 and the core 31 during insert molding of the nut 9.

The barrier 61 is formed at a mount end of the core 31 where the insert pin 41 is mounted. The barrier 61 is formed as a surround convex shape protruding along the edge of the core 31 with the insert pin 41 placed on the inside.

In one example, the barrier 61 may be formed in a circular cross-section shape at the edge portion of the core 31.

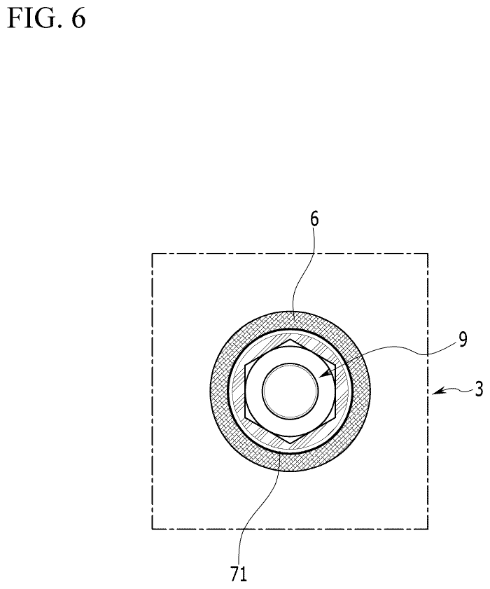

FIG. 6 is a drawing to explain the operation of a composite material parts forming apparatus according to an embodiment.

Referring to FIG. 1 to FIG. 6, the operation of a composite material parts forming apparatus 100 according to an embodiment configured as described above will be described in detail.

The gel-type composite material molding source 11 is sprayed into the lower mold 21 of the press mold 20.

The upper mold 23 of the press mold 20 is in a state of being moved in the upward direction. And, the mold pin assembly 30 is installed in the upper mold 23, and the nut 9 is fixed to the insert pin 41 of the mold pin assembly 30.

The sealing member 51 is inserted into the core connection pin portion 43 of the insert pin 41, and the core connection pin portion 43 is screw engaged into the pin engage hole 33 of the core 31.

The sealing member 51 is in close contact with the edge of the pin engage hole 33 and is secured to the stepped portion 49 between the core connection pin portion 43 and the nut connection pin portion 45.

The nut 9 is connected to the nut connection pin portion 45 of the insert pin 41 on the inside of the barrier 61 by the tight fitting (e.g., interference fitting, friction fitting, or force-fitting). The sealing member 51 seals between the nut connection pin portion 45 of the insert pin 41 and the nut 9.

In this state, when the upper mold 23 of the press mold 20 moves downward and merges with the lower mold 21, the plastic main body 4 and at least one boss portion 6 of a predetermined shape are molded by the flow of the composite material molding source 11.

In this process, the nut 9 fixed to the nut connection pin portion 45 of the insert pin 41 is inserted into at least one boss portion 6.

The barrier 61 formed at the edge portion of the core 31 with the insert pin 41 placed on the inside blocks the composite material molding source 11 flowing toward the nut 9 and blocks the composite material molding source 11 from inflowing into the interior of the nut 9 through the space between the nut connection pin portion 45 and the core 31.

When the composite material molding source 11 is hardened, the nut 9 is secured to at least one boss portion 6. Then, the upper mold 23 of the press mold 20 is released from the lower mold 21.

Then, as the upper mold 23 is released while the nut 9 is fixed to at least one boss portion 6, the mold pin assembly 30 is separated from the nut 9.

Accordingly, through a series of processes as described above, the manufacturing of the composite material panel 3 with the nut 9 inserted into at least one boss portion 6 is completed.

As shown in FIG. 6, the at least one boss portion 6 has an engraved groove 71 formed by the barrier 61, and the nut 9 is disposed inside the engraved groove 71.

The composite material parts forming apparatus 100 according to an embodiment described so far can block the composite material molding source 11 that inflows into the seat and interior of the nut 9 during insert molding of the nut 9 through the sealing member 51 and the barrier 61.

Therefore, the composite material parts forming apparatus 100 according to an embodiment can solve the quality problem of the composite material molding source 11 being caught in the nut 9.

Additionally, according to an embodiment of the composite material parts forming apparatus 100, the sealing member 51 is secured to the stepped portion 49 between the core connection pin portion 43 and the nut connection pin portion 45 of the insert pin 41.

Therefore, according to the composite material parts forming apparatus 100 according to an embodiment, since the sealing member 51 does not have to be manually replaced or mounted every time the composite material panel 3 is formed, work efficiency and equipment operability can be improved.

Furthermore, according to an embodiment of the composite material parts forming apparatus 100, since the sealing member 51 does not detach from the insert pin 41, the quality problem of the sealing member 51 being caught in the nut 9 as in the conventional art can be solved.

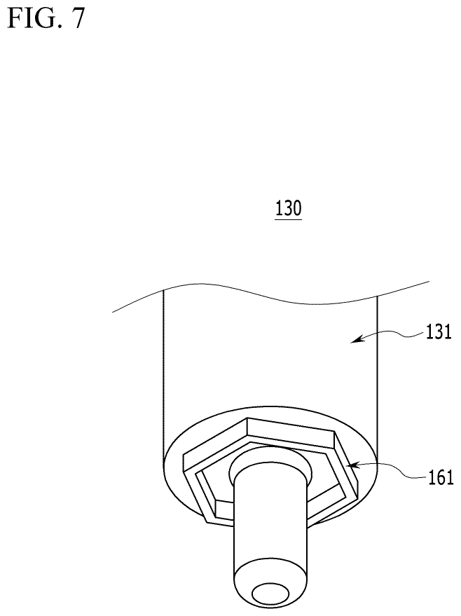

FIG. 7 is a drawing illustrating an exemplary variation of a mold pin assembly applied to the composite material parts forming apparatus according to an embodiment.

Referring to FIG. 7, in an exemplary variation of a mold pin assembly 130 according to an embodiment, a barrier 161 may be formed in the form of a polygonal cross-section at an edge portion of the core 131. In one example, the barrier 161 may be formed in the shape of a cross-section of a hexagon.

Although the preferred embodiments of the present invention have been described above, the embodiments of the present invention are not limited thereto, and various modifications may be made within the scope of the claims, the detailed description of the exemplary embodiments of the invention, and the attached drawings, which also fall within the scope of the embodiments of the present invention.

What is claimed is:

1. A composite material parts forming apparatus, the apparatus comprising:
a core mounted in a press mold;
an insert pin connected to the core and configured to secure a nut; and
a barrier which protrudes along an edge of the core with the insert pin disposed inside.

2. The apparatus of claim 1, wherein the core is mounted on an upper mold of the press mold.

3. The apparatus of claim 1, wherein the barrier has a circular cross-section shape at the edge of the core.

4. The apparatus of claim 1, wherein the barrier has a cross-section of a polygon at the edge of the core.

5. The apparatus of claim 1, further comprising a sealing member fixed between the core and the insert pin.

6. The apparatus of claim 5, wherein the insert pin comprises:
a core connection pin portion in which a male thread is disposed; and
a nut connection pin portion connected to the core connection pin portion with an exterior diameter larger than an exterior diameter of the core connection pin portion.

7. The apparatus of claim 6, wherein the core further comprises a pin engage hole having a female thread disposed on an inner surface to enable screw engagement with the core connection pin portion.

8. The apparatus of claim 7, wherein the sealing member is configured to be pressed against an edge of the pin engage hole and secured to a stepped portion between the core connection pin portion and the nut connection pin portion.

9. The apparatus of claim 1, wherein the nut comprises a cap nut that fits into the insert pin.

10. The apparatus of claim 9, wherein the nut is connected to the insert pin in tight fitting.

11. A composite material parts forming apparatus, the apparatus comprising:
a press mold comprising an upper mold and a lower mold; and
a mold pin assembly disposed in the upper mold, the mold pin assembly comprising:
an insert pin coupled to a core and configured to secure a nut for insertion into a molding material; and
a barrier which protrudes along an edge of the core with the insert pin disposed inside.

12. The apparatus of claim 11, wherein the insert pin comprises:
a core connection pin portion connected with the core; and
a nut connection pin portion connected with the nut.

13. The apparatus of claim 12, wherein:
a pin engage hole is disposed in the core; and
the core connection pin portion is engaged with the pin engage hole.

14. The apparatus of claim 13, wherein:
a female thread is disposed on an inner surface of the pin engage hole; and
a male thread is disposed on an exterior circumference surface of the core connection pin portion, the male thread being configured to be screw engaged with the female thread.

15. The apparatus of claim 14, further comprising a sealing member configured to seal between the nut connection pin portion of the insert pin and the nut.

16. The apparatus of claim 15, wherein in a state in which the sealing member is fitted into the core connection pin portion and the core connection pin portion is screw engaged into the pin engage hole of the core, the sealing member is in close contact with an edge of the pin engage hole and secured to a stepped portion between the core connection pin portion and the nut connection pin portion.

17. The apparatus of claim 11, wherein the barrier has a circular cross-section shape at the edge of the core.

18. The apparatus of claim 11, wherein the barrier has a cross-section of a polygon at the edge of the core.

19. The apparatus of claim 11, wherein the nut comprises a cap nut that fits into the insert pin.

20. The apparatus of claim 19, wherein the nut is connected to the insert pin in tight fitting.
